(19) United States
(12) Patent Application Publication
(10) Pub. No.: US 2024/0257814 A1
(43) Pub. Date: Aug. 1, 2024

(54) LEARNING APPARATUS, LEARNING METHOD AND PROGRAM

(71) Applicant: NIPPON TELEGRAPH AND TELEPHONE CORPORATION, Tokyo (JP)

(72) Inventors: Daisuke NIIZUMI, Musashino-shi (JP); Yasunori OISHI, Musashino-shi (JP); Daiki TAKEUCHI, Musashino-shi (JP); Noboru HARADA, Musashino-shi (JP); Kunio KASHINO, Musashino-shi (JP)

(73) Assignee: NIPPON TELEGRAPH AND TELEPHONE CORPORATION, Tokyo (JP)

(21) Appl. No.: 18/290,495

(22) PCT Filed: May 17, 2021
(86) PCT No.: PCT/JP2021/018586

§ 371 Date: Nov. 14, 2023

(51) Int. Cl. G10L 17/04; G10L 17/02

(52) U.S. Cl. CPC G10L 17/04; G10L 17/02

(57) ABSTRACT

One aspect of the present invention is a learning device including a self-learning unit that updates content of main conversion processing for converting data to be processed into data in a predetermined format by executing self-supervised learning, and a data augmentation unit that executes data augmentation processing of generating data to be processed in the main conversion processing based on an acoustic time series, in which the data augmentation unit performs acoustic time series clipping processing of clipping a partial time series that is a time series of a part of the acoustic time series, duplication processing of duplicating the partial time series, and conversion processing of converting one and the other of the partial time series according to a predetermined rule, and the self-learning unit updates the content of the main conversion processing by self-supervised learning based on a result obtained by the conversion processing.

### TECHNICAL FIELD

The present invention relates to a learning apparatus, a learning method and a program.

### BACKGROUND ART

A technique for generating a mathematical model for converting input acoustic data into a predetermined format by a method of self-supervised learning such as control learning is known.

### CITATION LIST

### Non Patent Literature

Non Patent Literature 1: A. Saeed et. al., “Contrastive learning of general-purpose audio representations” arXiv preprintarXiv::2010.10915, 2020.

### SUMMARY OF INVENTION

### Technical Problem

In learning used to generate a mathematical model that converts acoustic time series that is a time series of an acoustic sound, a pair of segments clipping from different times of one acoustic time series is used. At this time, a learning algorithm designed on the assumption that the similarity between one and the other of the pairs becomes higher as the time interval becomes shorter and the similarity becomes lower as the time interval becomes longer is created.

However, such an assumption is not necessarily true in some cases. In such a case, the conversion of the acoustic time series may not be appropriately performed. That is, the accuracy of the conversion of the acoustic time series may be low.

In view of the above circumstances, an object of the present invention is to provide a technique for improving the accuracy of conversion of an acoustic time series that is a time series of an acoustic sound.

### Solution to Problem

One aspect of the present invention is a learning device including a self-learning unit that updates content of main conversion processing for converting data to be processed into data in a predetermined format by executing self-supervised learning, and a data augmentation unit that executes data augmentation processing of generating data to be processed in the main conversion processing based on an acoustic time series, in which the data augmentation unit performs acoustic time series clipping processing of clipping a partial time series that is a time series of a part of the acoustic time series, duplication processing of duplicating the partial time series, and conversion processing of converting one and the other of the partial time series according to a predetermined rule, and the self-learning unit updates the content of the main conversion processing by self-supervised learning based on a result obtained by the conversion processing.

An aspect of the present invention is a learning method including a self-learning step of updating content of main conversion processing for converting data to be processed into data in a predetermined format by executing self-supervised learning, and a data augmentation step of executing data augmentation processing of generating data to be processed in the main conversion processing based on an acoustic time series, in which in the data augmentation step, acoustic time series clipping processing of clipping a partial time series that is a time series of a part of the acoustic time series, duplication processing of duplicating the partial time series, and conversion processing of converting one and the other of the partial time series according to a predetermined rule are performed, and in the self-learning step, the content of the main conversion processing by self-supervised learning based on a result obtained by the conversion processing is performed.

One aspect of the present invention is a program for causing a computer to function as the learning device.

### Advantageous Effects of Invention

According to the present invention, it is possible to improve the accuracy of conversion of an acoustic time series that is a time series of an acoustic sound.

### BRIEF DESCRIPTION OF DRAWINGS

FIG. 1 is a diagram illustrating an example of a configuration of an acoustic conversion system according to an embodiment.

FIG. 2 is an explanatory diagram for illustrating data augmentation processing according to the embodiment.

FIG. 3 is an explanatory diagram for illustrating acoustic image deformation processing according to the embodiment.

FIG. 4 is an explanatory diagram for illustrating an example of self-learning execution processing in the embodiment.

FIG. 5 is a diagram illustrating an example of a hardware configuration of the learning device of the embodiment.

FIG. 6 is a diagram illustrating an example of a configuration of a control unit included in the learning device of the embodiment.

FIG. 7 is a flowchart illustrating an example of a flow of processing executed by the learning device according to the embodiment.

FIG. 8 is a diagram illustrating an example of a hardware configuration of the conversion device according to the embodiment.

FIG. 9 is a diagram illustrating an example of a configuration of a control unit included in the conversion device of the embodiment.

FIG. 10 is a flowchart illustrating an example of a flow of processing executed by the conversion device according to the embodiment.

FIG. 11 is a first diagram illustrating a result of an experiment using the acoustic conversion system of the embodiment.

FIG. 12 is a second diagram illustrating a result of an experiment using the acoustic conversion system of the embodiment.

### DESCRIPTION OF EMBODIMENTS

### Embodiment

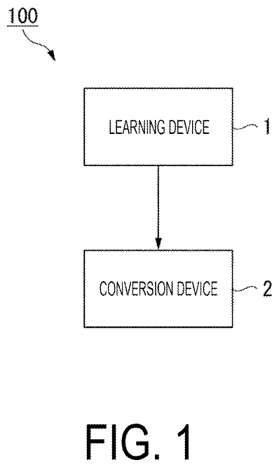

FIG. 1 is a diagram illustrating an example of a configuration of an acoustic conversion system 100 of an embodiment. The acoustic conversion system 100 includes a learning device 1 and a conversion device 2. The learning device 1 updates the content of processing (hereinafter, referred to as “acoustic conversion processing”) of converting the input acoustic time series into data in a predetermined format (hereinafter, referred to as a “target format”) by learning. The data in the target format is, for example, representation embedding. The acoustic conversion processing is a type of learning model. The acoustic time series is a time series of an acoustic sound.

The acoustic time series is represented by a tensor. The acoustic time series may be, for example, a tensor of the second order (that is, a matrix) indicating the frequency at each time and the intensity of the frequency component, and the value of the element may be a tensor indicating the intensity of the frequency component. The acoustic time series may be, for example, a third-order tensor representing a set of a channel, a frequency, and an intensity of a frequency component at each time, and a value of an element may be a tensor representing the intensity of the frequency component.

The acoustic time series may be, for example, a first-order tensor (that is, vector) indicating the intensity of the acoustic sound at each time. Hereinafter, the acoustic conversion system 100 will be described using a case where a tensor represents an intensity of a frequency component as an example. The intensity indicated by the value of the element of the tensor is the intensity of the frequency component in a case where the tensor is a tensor of a second or higher order.

Hereinafter, a quantity indicated by each dimension of the tensor representing the acoustic time series is referred to as a non-intensity quantity. One of the non-intensity quantities is, for example, time. One of the non-intensity quantities is, for example, frequency.

The target format is, for example, a format of data of 512 floating point numerical values. The target format may be, for example, a format of data of 1024 floating point values. The target format may be, for example, a format of data of 2048 floating point values.

The learning device 1 executes self-learning execution processing and data augmentation processing. The self-learning execution processing is processing of executing self-supervised learning such as bootstrap your own latent (BYOL). Hereinafter, processing for executing self-supervised learning is referred to as self-learning processing.

The learning model updated by the execution of the self-learning processing is processing (hereinafter, referred to as “main conversion processing”) of converting data obtained by the execution of the data augmentation processing into data in a target format. The main conversion processing is also a type of learning model. A relationship between the acoustic conversion processing and the main conversion processing will be described. The acoustic conversion processing includes main conversion processing. More specifically, the acoustic conversion processing includes data augmentation processing and main conversion processing.

The data augmentation processing is processing of generating data (hereinafter, referred to as “main processing target data”) to be subjected to the main conversion processing. In the self-learning processing, the main conversion processing is executed on the main processing target data, and the content of the main conversion processing is updated using a result of the execution. Therefore, the main processing target data is also the processing target data of the self-learning processing at the time of learning of the main conversion processing.

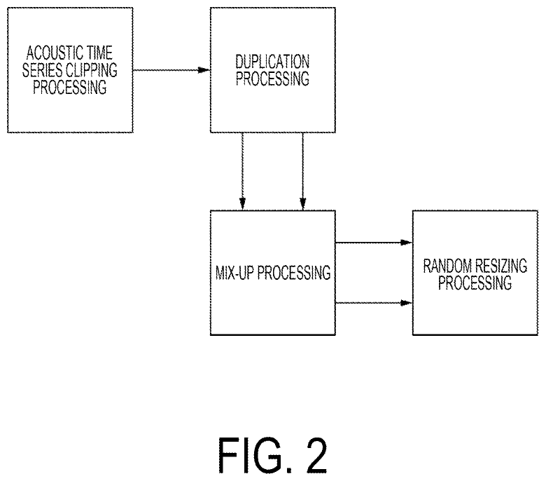

FIG. 2 is an explanatory diagram for illustrating data augmentation processing according to the embodiment. The data augmentation processing includes at least acoustic time series clipping processing, duplication processing, mix-up processing, and random resizing processing.

The acoustic time series clipping processing is processing of acquiring a time series of a part of an acoustic time series (hereinafter, referred to as the “clipping target time series”) of a processing target (hereinafter referred to as “processing target”). Hereinafter, a time series that is a part of the clipping target time series and is obtained by the acoustic time series clipping processing is referred to as a partial time series. The length of the partial time series may be equal to or less than the length of the clipping target time series, or may be longer than the clipping target time series. In a case where the length of the partial time series is longer than the clipping target time series, the value of the sample of the time series of the difference between the length of the partial time series and the length of the clipping target time series is a predetermined value such as zero.

The duplication processing is processing of duplicating the partial time series. Although the two partial time series obtained by duplication processing are the same time series, for simplicity of explanation, the two partial time series obtained by the duplication processing will be referred to as a first partial time series and a second partial time series, respectively. Note that the first partial time series is, for example, a partial time series of the duplication source, and the second partial time series is a time series obtained by duplicating the partial time series of the duplication source. Both the first partial time series and the second partial time series may be time series obtained by duplicating the partial time series of the duplication source.

The mix-up processing is performed on each of the first partial time series and the second partial time series. The mix-up processing includes first weighted average processing and second weighted average processing. The first weighted average processing is processing of obtaining the first mixing time series. The first mixing time series is a time series satisfying the first representation tensor condition. The first representation tensor condition includes a first order number condition and a first element condition. The first order condition is a condition that the order of the tensor representing the first mixing time series is the same as that of the first partial time series.

The first element condition is a condition that the element of the tensor representing the first mixing time series is a weighted average of the element of the tensor representing the first partial time series and the element of the tensor representing the first mixed time series and having the same order as the first partial time series. The weight in the weighted average may be a randomly determined weight or a weight determined according to a predetermined rule. The first mixed time series is another time series different from the first partial time series.

The second weighted average processing is processing of obtaining the second mixing time series. The second mixing time series is a time series satisfying the second representation tensor condition. The second representation tensor condition includes a second order number condition and a second element condition. The second order condition is a condition that the order of the tensor representing the second mixing time series is the same as that of the second partial time series.

The second element condition is a condition that the element of the tensor representing the second mixing time series is a weighted average of the element of the tensor representing the second partial time series and the element of the tensor representing the second mixed time series and having the same order as the second partial time series. The weight in the weighted average may be a randomly determined weight or a weight determined according to a predetermined rule. The second mixed time series may be at least a time series different from the first mixed time series, and is, for example, a time series different from the second partial time series and the first mixed time series. The second mixed time series may be a time series different from the first partial time series, the second partial time series, and the first mixed time series.

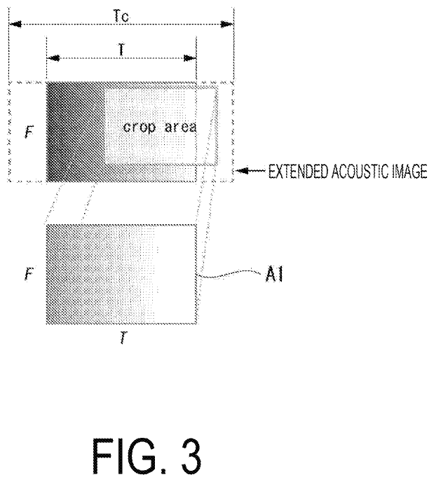

The random resizing processing is performed on each of the first mixing time series and the second mixing time series. The random resizing processing includes first random resizing processing and second random resizing processing. The first random resizing processing is acoustic image deformation processing executed on the first mixing time series. Although details of the acoustic image deformation processing will be described later, the acoustic image deformation processing is processing executed on the acoustic image. The acoustic image is an image representing an acoustic time series. More specifically, the acoustic image is information indicating intensity for each set of frequency and time. The second resizing processing is acoustic image deformation processing executed on the second mixing time series. The definition of the acoustic image deformation processing will be described with reference to FIG. 3.

FIG. 3 is an explanatory diagram for illustrating acoustic image deformation processing according to the embodiment. The acoustic image deformation processing includes extended acoustic image data generation processing, acoustic image data extraction processing, and resizing processing. The extended acoustic image data generation processing is processing of adding zero acoustic image data to data (hereinafter, referred to as “target acoustic image data”) indicating acoustic images representing a time series to be processed.

As described above, the acoustic image is information indicating intensity for each set of frequency and time. Therefore, a technique of image processing can be applied to the acoustic image. Hereinafter, data indicating an acoustic image is referred to as acoustic image data.

The zero acoustic image data is a tensor in which all the element values are 0. That is, the zero acoustic image data indicates a time series in which all sample values are 0.

Hereinafter, the target acoustic image data after the addition of the zero acoustic image data is referred to as expanded acoustic image data. In the example of FIG. 2, the image having the height F and the length T is the acoustic image indicated by the target acoustic image data. F in the example of FIG. 2 is a frequency, and the length T is time. In the example of FIG. 3, the expanded acoustic image which is an image having the height F and the length Tc is an image indicated by the expanded acoustic image data.

The acoustic image data extraction processing is processing of acquiring a part of the extended acoustic image data. Hereinafter, the acoustic image data obtained by the acoustic image data extraction processing is referred to as partial acoustic image data. In the example of FIG. 3, an image in a region described as “crop area” is the acoustic image indicated by the partial acoustic image data.

The resizing processing is processing of deforming the acoustic image indicated by the partial acoustic image data into the same size as the acoustic image indicated by the target acoustic image data. In the size variation, the acoustic image may be enlarged or reduced. The enlargement of the acoustic image means to increase the number of samples in time series. The reduction of the acoustic image means to reduce the number of samples in time series.

When the number of samples in time series is increased, the number of samples is increased by a predetermined interpolation method. When the number of samples in time series is reduced, the number of samples is reduced according to a predetermined rule. In the example of FIG. 3, an image A1 is an example of the acoustic image indicated by the acoustic image data obtained by the resizing processing. In the example of FIG. 3, the image A1 is an acoustic image obtained by enlarging an acoustic image of “crop area”.

As described above, since the time series is expressed by a tensor, the acoustic image deformation processing is expressed by a tensor. The extended acoustic image data generation processing is processing of increasing the number of elements of the tensor representing the time series. That is, the extended acoustic image data generation processing is processing of adding zero acoustic image data before and after a tensor representing a time series. The acoustic image data extraction processing is processing of extracting a part of the elements of the tensor represented by the extended acoustic image data. The resizing processing is processing of changing the size of the tensor obtained by the acoustic image data extraction processing to the size of the tensor of the target acoustic image data.

As described above, the acoustic image deformation processing is processing of executing affine conversion on at least a part of the acoustic images indicating the time series to be processed.

By executing the random resizing processing, the first random resizing processing and the second random resizing processing are executed, and a result of executing the acoustic image deformation processing on the first mixing time series and a result of executing the acoustic image deformation processing on the second mixing time series are obtained. Hereinafter, a result of executing the acoustic image deformation processing on the first mixing time series is referred to as first extended data. Hereinafter, a result of executing the acoustic image deformation processing on the second mixing time series is referred to as second extended data. A set of the first extended data and the second extended data is an example of the main processing target data.

Note that the random resizing processing is not necessarily executed for each of the first mixing time series and the second mixing time series. The random resizing processing may be executed on the first partial time series instead of the first mixing time series, and may be executed on the second partial time series instead of the second mixing time series. As described above, both of the mix-up processing and the random resizing processing are not necessarily performed, and only one of them may be performed.

Hereinafter, processing of acquiring the main processing target data based on the result of the duplication processing is referred to as conversion processing. That is, the conversion processing is processing of converting one and the other of the acoustic time series obtained by the duplication processing according to a predetermined rule. The predetermined rule is, for example, a rule in which random resizing processing is performed on the result of the mix-up processing after the mix-up processing is executed, and the result of the random resizing processing is acquired as the main processing target data. The predetermined conversion may be, for example, a rule of performing mix-up processing and acquiring a result of the mix-up processing as main processing target data.

The learning device 1 executes the self-learning execution processing as described above. That is, the learning device 1 executes the self-learning processing using the main processing target data obtained in the data augmentation processing. The learning device 1 updates the content of the main conversion processing by executing the self-learning processing using the main processing target data. Since the main conversion processing is included in the acoustic conversion processing, the update of the content of the main conversion processing is the update of the content of the acoustic conversion processing.)

Hereinafter, the acoustic conversion processing at the time when the predetermined end condition is satisfied is referred to as learned acoustic conversion processing. The end condition is, for example, a condition that learning has been performed a predetermined number of times. The end condition may be, for example, a condition that a change in the content of the acoustic conversion processing based on learning is smaller than a predetermined change.

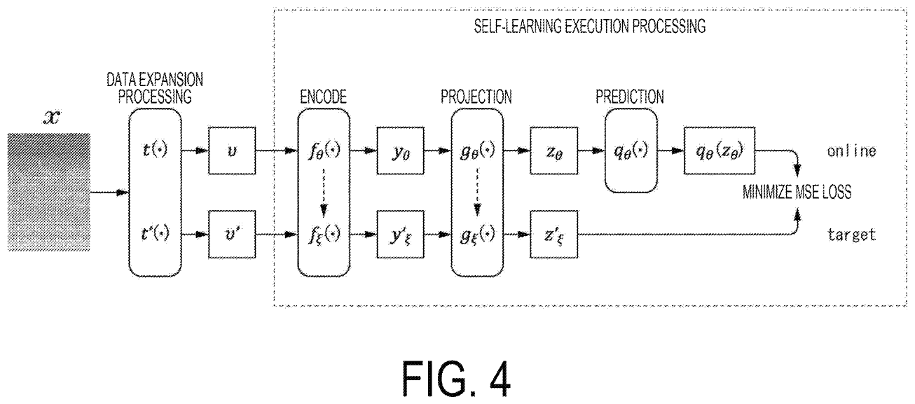

FIG. 4 is an explanatory diagram illustrating an example of self-learning execution processing according to the embodiment. In FIG. 4, v represents the first extended data obtained by the data augmentation processing. In FIG. 4, v′ represents the second extended data obtained by the data augmentation processing. FIG. 4 illustrates that the self-learning execution processing is executed after the execution of the data augmentation processing. In the self-learning execution processing, for example, processing of encoding, projection, and prediction defined by BYOL is executed. In BYOL, for example, the content of the main conversion processing is updated so as to minimize a mean squared error (MSE) loss.

The description returns to FIG. 1. The conversion device 2 executes learned acoustic conversion processing to convert the acoustic time series to be converted into data in a target format.

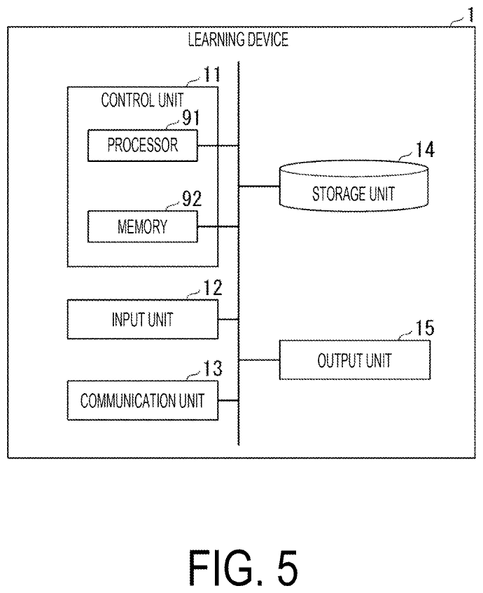

FIG. 5 is a diagram illustrating an example of a hardware configuration of the learning device 1 according to the embodiment. The learning device 1 includes a control unit 11 including a processor 91 such as a central processing unit (CPU) and a memory 92, which are connected by a bus, and executes a program. The learning device 1 functions as a device including a control unit 11, an input unit 12, a communication unit 13, a storage unit 14, and an output unit 15 by executing a program.

More specifically, the processor 91 reads the program stored in the storage unit 14, and stores the read program in the memory 92. The processor 91 executes the program stored in the memory 92, whereby the learning device 1 functions as a device including the control unit 11, the input unit 12, the communication unit 13, the storage unit 14, and the output unit 15.

The control unit 11 controls operations of various functional units included in the learning device 1. The control unit 11 executes, for example, data augmentation processing and self-learning execution processing. The control unit 11 controls, for example, the operation of the output unit 15. The control unit 11 records, for example, various types of information generated by execution of the data augmentation processing and the self-learning execution processing in the storage unit 14.

The input unit 12 includes an input device such as a mouse, a keyboard, and a touch panel. The input unit. 12 may be configured as an interface that connects these input devices to the learning device 1. The input unit 12 receives inputs of various types of information to the learning device 1.

The communication unit 13 includes a communication interface for connecting the learning device 1 to an external device. The communication unit 13 communicates with the external device in a wired or wireless manner. The external device is, for example, a device from which an acoustic signal is transmitted. The external device is, for example, the conversion device 2.

The storage unit 14 is configured using a computer-readable storage medium device such as a magnetic hard disk device or a semiconductor storage device. The storage unit 14 stores various types of information regarding the learning device 1. The storage unit 14 stores, for example, information input via the input unit 12 or the communication unit 13. The storage unit 14 stores, for example, various types of information generated by execution of the data augmentation processing and the self-learning execution processing.

The output unit 15 outputs various types of information. The output unit 15 is configured to include, for example, a display device such as a cathode ray tube (CRT) display, a liquid crystal display, or an organic electro-luminescence (EL) display. The output unit 15 may be configured as an interface connecting such a display device to the learning device 1. The output unit 15 outputs, for example, information input to the input unit 12. The output unit 15 may display, for example, an execution result of the data augmentation processing and the self-learning execution processing.

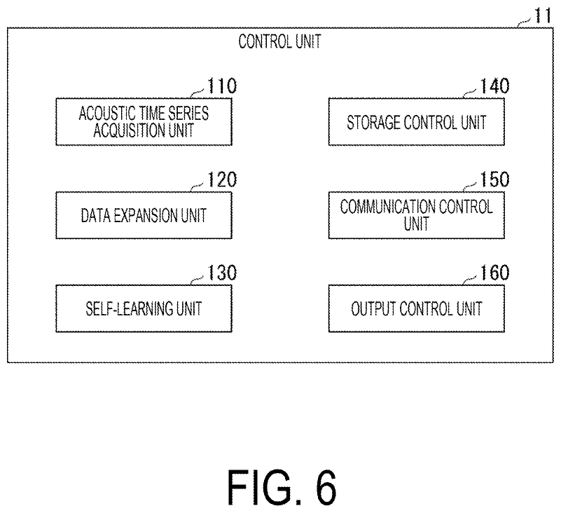

FIG. 6 is a diagram illustrating an example of a configuration of the control unit 11 according to the embodiment. The control unit 11 includes an acoustic time series acquisition unit 110, a data augmentation unit 120, a self-learning unit 130, a storage control unit 140, a communication control unit 150, and an output control unit 160. The acoustic time series acquisition unit 110 acquires the acoustic time series input to the communication unit 13. The data augmentation unit 120 acquires main processing target data by performing data augmentation processing on the acoustic time series acquired by the acoustic time series acquisition unit 110.

The self-learning unit 130 executes self-learning processing using the main processing target data. The self-learning unit 130 also executes end determination processing. The end determination processing is processing of determining whether or not a predetermined end condition is satisfied. In a case where a predetermined end condition is satisfied, the self-learning unit 130 ends the execution of the self-learning processing.

The storage control unit 140 records various types of information in the storage unit 14. The communication control unit 150 controls the operation of the communication unit 13. The output control unit 160 controls the operation of the output unit 15.

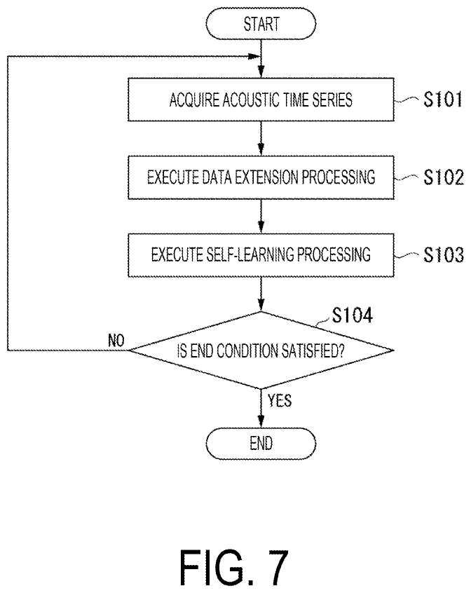

FIG. 7 is a flowchart illustrating an example of a flow of processing executed by the learning device 1 according to the embodiment. The acoustic time series acquisition unit 110 acquires the acoustic time series (step S101). Next, the data augmentation unit 120 executes data augmentation processing on the acoustic time series acquired in step S101 (step S102). Next, the data augmentation unit 120 acquires the main processing target data by executing the data augmentation processing. Next, the self-learning unit 130 executes self-learning processing based on the main processing target data acquired in step S102 (step S103). The content of the acoustic conversion processing is updated by execution of the self-learning processing.

Next, the self-learning unit 130 executes end determination processing (step S104). In a case where the end condition is satisfied (step S104: YES), the processing ends. On the other hand, when the end determination condition is not satisfied (step S104: NO), the processing returns to step S101.

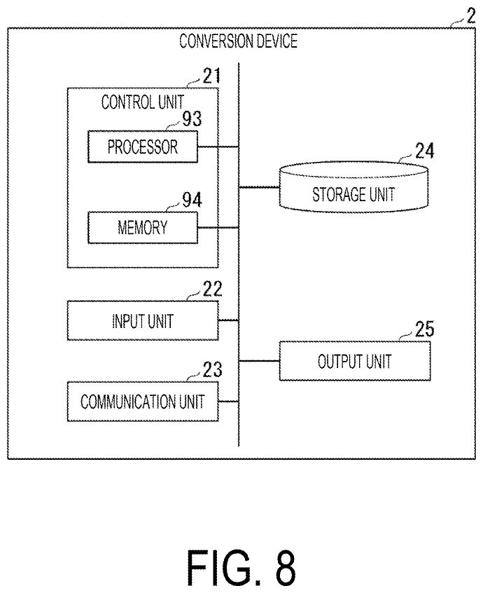

FIG. 8 is a diagram illustrating an example of a hardware configuration of the conversion device 2 according to the embodiment. The conversion device 2 includes a control unit 21 including a processor 93 such as a CPU and a memory 94 connected via a bus, and executes a program. The conversion device 2 functions as a device including the control unit 21, an input unit 22, a communication unit 23, a storage unit 24, and an output unit 25 by executing a program.

More specifically, the processor 93 reads the program stored in the storage unit 24, and stores the read program in the memory 94. When the processor 93 executes the program stored in the memory 94, the conversion device 2 functions as a device including the control unit 21, the input unit 22, the communication unit 23, the storage unit 24, and the output unit 25.

The control unit 21 controls operations of various functional units included in the conversion device 2. For example, the control unit 21 acquires information indicating the content of the learned acoustic conversion processing obtained by the learning device 1 and records the information in the storage unit 24. The control unit 21 executes learned acoustic conversion processing. In the execution of the learned acoustic conversion processing by the control unit 21, for example, the control unit 21 reads and executes information indicating the content of the learned acoustic conversion processing recorded in the storage unit 24, so that the learned acoustic conversion processing is executed. The control unit 21 controls, for example, the operation of the output unit 25. The control unit 21 records, for example, various types of information generated by execution of the learned acoustic conversion processing in the storage unit 24.

The input unit 22 includes an input device such as a mouse, a keyboard, or a touch panel. The input unit 22 may be configured as an interface that connects these input devices to the conversion device 2. The input unit 22 receives inputs of various types of information to the conversion device 2.

The communication unit 23 includes a communication interface for connecting the conversion device 2 to an external device. The communication unit 23 communicates with an external device in a wired or wireless manner. The external device is, for example, a device from which an acoustic signal is transmitted. The external device is, for example, the learning device 1. The communication unit 23 acquires information indicating the content of the learned acoustic conversion processing by communication with the learning device 1.

The storage unit 24 is configured using a computer-readable storage medium device such as a magnetic hard disk device or a semiconductor storage device. The storage unit 24 stores various types of information regarding the conversion device 2. The storage unit 24 stores, for example, information input via the input unit 22 or the communication unit 23. The storage unit 24 stores, for example, various types of information generated by execution of learned acoustic conversion processing. The storage unit 24 stores, for example, the content of the learned acoustic conversion processing.

The output unit 25 outputs various types of information. The output unit 25 includes, for example, a display device such as a CRT display, a liquid crystal display, or an organic EL display. The output unit 25 may be configured as an interface that connects these display devices to the conversion device 2. The output unit 25 outputs, for example, information input to the input unit 22. The output unit 25 may display, for example, an execution result of the learned acoustic conversion processing.

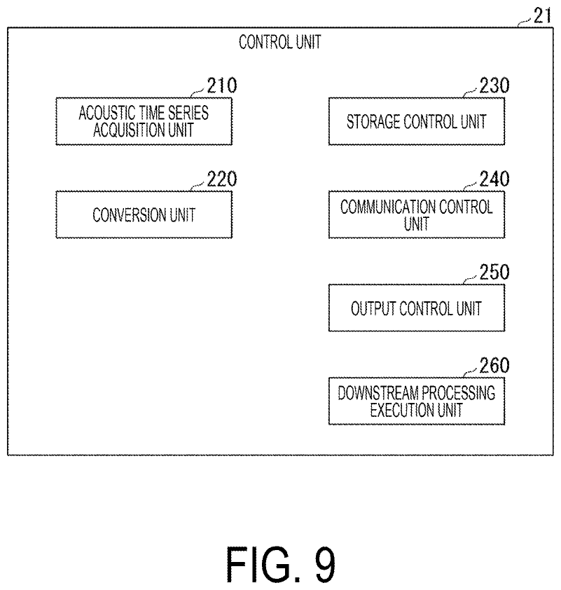

FIG. 9 is a diagram illustrating an example of a configuration of the control unit 21 according to the embodiment. The control unit 21 includes an acoustic time series acquisition unit 210, a conversion unit 220, a storage control unit 230, a communication control unit 240, an output control unit 250, and a downstream processing execution unit 260. The acoustic time series acquisition unit 210 acquires the acoustic time series input to the communication unit 23. The conversion unit 220 executes learned acoustic conversion processing on the acoustic time series acquired by the acoustic time series acquisition unit 210. The conversion unit 220 obtains data in the target format by executing the learned acoustic conversion processing.

The storage control unit 230 records various types of information in the storage unit 24. The communication control unit 240 controls the operation of the communication unit 23. The output control unit 250 controls the operation of the output unit 25.

The downstream processing execution unit 260 executes downstream processing. The downstream processing may be any processing as long as it is processing using the data in the target format obtained by the conversion unit 220. The downstream processing is, for example, processing (hereinafter, referred to as “abnormality detection processing”) of determining whether or not a predetermined abnormal sound is included in the acoustic sound indicated by the acoustic time series input to the conversion device 2 based on the data in the target format of the acoustic time series input to the conversion device 2. The predetermined abnormal sound is instructed by the user to the conversion device 2 via the input unit 22, for example. The predetermined abnormal sound candidate may be stored in advance in the storage unit 24, for example, or may be stored in a predetermined storage device on a network connected to the conversion device 2 via the communication unit 23. Note that the acoustic time series input to the conversion device 2 is the time series acquired by the acoustic time series acquisition unit 210.

The downstream processing execution unit 260 executes downstream processing model. The downstream processing model is a learned learning model obtained in advance by a machine learning method or the like. The downstream processing model is a learned learning model that executes downstream processing. The downstream processing execution unit 260 executes downstream processing by executing the downstream processing model.

The downstream processing may be, for example, processing (hereinafter, referred to as “music determination processing”) of determining whether or not the acoustic sound indicated by the acoustic time series input to the conversion device 2 is an acoustic sound of a predetermined music based on the data in the target format of the acoustic time series input to the conversion device 2. The predetermined music is instructed by the user to the conversion device 2 via the input unit 22, for example. The predetermined music candidate may be stored in advance in the storage unit 24, for example, or may be stored in a predetermined storage device on a network connected to the conversion device 2 via the communication unit 23.

The downstream processing may be, for example, processing (hereinafter, referred to as “music search processing”) of searching for a music having a high degree of similarity to the acoustic time series input to the conversion device 2 on the basis of the data in the target format of the acoustic time series input to the conversion device 2. The candidate of the music to be searched in the music search processing may be stored in advance in the storage unit 24, for example, or may be stored in a predetermined storage device on a network connected to the conversion device 2 via the communication unit 23.

The downstream processing may be, for example, processing of estimating the attribute of the speaker who has uttered the voice indicated by the acoustic time series input to the conversion device 2 on the basis of the data in the target format of the acoustic time series input to the conversion device 2 (hereinafter, referred to as “speaker attribute estimation processing”).

The downstream processing may be, for example, processing of determining whether or not the speaker who has uttered the voice indicated by the acoustic time series input to the conversion device 2 is a predetermined speaker on the basis of the data in the target format of the acoustic time series input to the conversion device 2 (hereinafter, referred to as “speaker determination processing”). For the predetermined speaker in the speaker determination processing, for example, the user instructs the conversion device 2 via the input unit 22. The candidate for the predetermined speaker may be stored in advance in, for example, the storage unit 24, or may be stored in a predetermined storage device on a network connected to the conversion device 2 via the communication unit 23.

The downstream processing may be, for example, processing of determining whether or not the voice indicated by the acoustic time series input to the conversion device 2 is a predetermined voice on the basis of the data in the target format of the acoustic time series input to the conversion device 2 (hereinafter, referred to as “voice determination processing”). The predetermined voice in the voice determination processing is, for example, instructed by the user to the conversion device 2 via the input unit 22. The candidate for the predetermined voice may be stored in advance in, for example, the storage unit 24, or may be stored in a predetermined storage device on a network connected to the conversion device 2 via the communication unit 23.

The downstream processing may be, for example, processing (hereinafter, referred to as “acoustic conversion processing”) of converting the sound indicated by the acoustic time series input to the conversion device 2 into a sound having a predetermined attribute on the basis of the data in the target format of the acoustic time series input to the conversion device 2. The predetermined attribute may be, for example, an attribute of male. In such a case, the female voice is converted into the male voice by the acoustic conversion processing. The attribute of the sound of the conversion destination in the acoustic conversion processing is instructed by the user to the conversion device 2 via the input unit 22, for example. The attribute candidates of the sound of the conversion destination may be stored in advance in the storage unit 24, for example, or may be stored in a predetermined storage device on a network connected to the conversion device 2 via the communication unit 23.

A moving image may be input to the conversion device 2. In such a case, the acoustic time series acquisition unit 210 acquires the voice data of the moving image as acoustic time series. In such a case, the conversion unit 220 converts the acoustic time series of the voice data of the moving image acquired by the acoustic time series acquisition unit 210 into data in the target format. In such a case, the downstream processing execution unit 260 detects the timing at which the predetermined condition is satisfied on the basis of the data in the target format. The predetermined condition is, for example, a condition that the voice is filled with anger. Next, the downstream processing execution unit 260 performs processing of superimposing a predetermined image such as highlight display on the image (that is, the frame) at the timing when the moving image is detected. As described above, the downstream processing may be processing (Hereinafter, referred to as “moving image processing”.) of processing the moving image having the acoustic time series before the conversion of the data in the target format on the basis of the data in the target format.

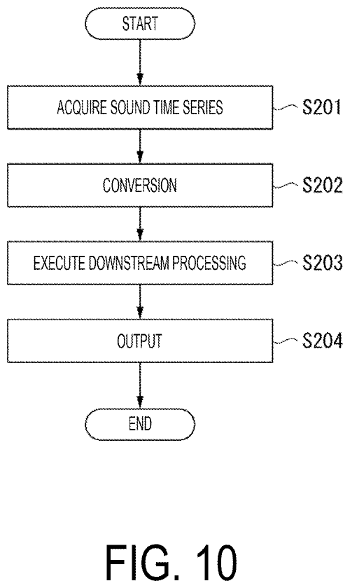

FIG. 10 is a flowchart illustrating an example of a flow of processing executed by the conversion device 2 in the embodiment. The acoustic time series acquisition unit 210 acquires the acoustic time series input to the communication unit 23 (step S201). Next, the conversion unit 220 executes learned acoustic conversion processing on the acoustic time series acquired in step S201 (step S202). By execution of the learned acoustic conversion processing, the acoustic time series acquired in step S201 is converted into data in a target format. That is, data in the target format is generated by executing the learned acoustic conversion processing. Next, the downstream processing execution unit 260 executes downstream processing (step S203).

The downstream processing executed in step S203 is predetermined downstream processing, and is, for example, abnormality detection processing. The downstream processing executed in step S203 may be, for example, music determination processing. The downstream processing executed in step S203 may be, for example, music search processing. The downstream processing executed in step S203 may be, for example, speaker attribute estimation processing. The downstream processing executed in step S203 may be, for example, speaker determination processing. The downstream processing executed in step S203 may be, for example, voice determination processing. The downstream processing executed in step S203 may be, for example, acoustic conversion processing. The downstream processing executed in step S203 may be, for example, moving image processing.

After step S203, the output control unit 250 controls the operation of the output unit 25 to cause the output unit 25 to output the result of the downstream processing (step S204).

### <Experiment Result

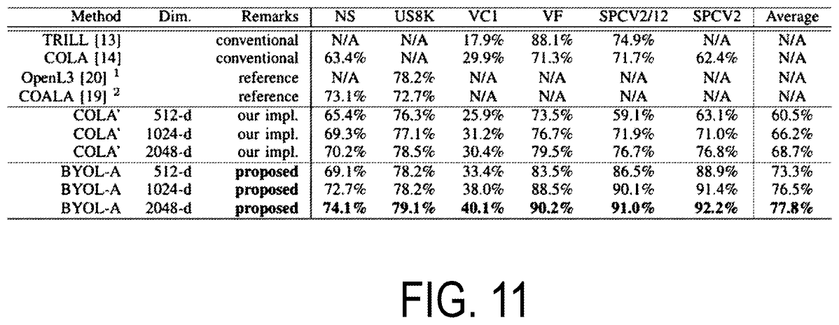

A result of an experiment using the acoustic conversion system 100 will be described. In the experiment, pre-normalization processing described below was also performed. FIG. 11 is a first diagram illustrating a result of an experiment using the acoustic conversion system 100 of the embodiment. The TRILL method, the COLA method, the OpenL3 method, and the COALA method are used in the order of “TRILL [13]”, “COLA [14]”, “Opent3 [20]”, and “COALA [19]” in the column of “Method” in FIG. 11. That is, “TRILL [13]”, “COLA [14]”, “OpenL3 [20]” and “COALA [19]” are all prior art methods used as comparison targets. Each “COLA′” is each an optimized “COLA [14]”. “BYOL-A” in the column of “Method” indicates a method of downstream processing by the acoustic conversion system 100.

Specifically, the downstream processing method by the acoustic conversion system 100 is a method in which the conversion unit 220 obtains data in the target format by executing the learned acoustic conversion processing, and the downstream processing execution unit 260 executes the downstream processing by using the obtained data in the target format. In the experiments, downstream processing was a classification task. “TRILL [13]”, “COLA [14]”, “OpenL3 [20]”, “COALA [19]”, and “COLA” are techniques used as comparison targets to evaluate the performance of the acoustic conversion system 100.

Note that “TRILL [13]”, “COLA [14]”, “OpenL3 [20]”, and “COALA [19]” are methods described in the following references literature, respectively. More specifically, “TRILL [13]” is the method described in Reference Literature 1, “COLA [14]” is the method described in Reference Literature 2, “OpenL3 [20]” is the method described in Reference 3, and “COALA [19]” is the method described in Reference Literature 4.

Reference Literature 1: J. Shor, A. Jansen, R. Maor, O. Lang, O. Tuval, F. de C. Quitry, M. Tagliasacchi, I. Shavitt, D. Emanuel, and Y. Haviv, “Towards learning a universal non-semantic representation of speech”, arXiv preprint arXiv::2002.12764, 2020.

Reference Literature 2: A. Saeed, D. Grangier, and N. Zeghidour, “Contrastive learning of general-purpose audio representations”, arXiv preprintarXiv::2010.10915, 2020.

Reference Literature 3: J. Cramer, H.-H. Wu, J. Salamon, and J. P. Bello, “Look, listen and learn more: Design choices for deep audio embeddings”, in ICASSP, Brighton, UK, May 2019, pp. 3852-3856.

Reference Literature 4: X. Favory, K. Drossos, T. Virtanen, and X. Serra, “Coala: Co-aligned autoencoders for learning semantically enriched audio representations”.

“Remarks” in FIG. 11 indicates special notes regarding each method described in the column of “Method”. “our ompl” represents the result of COLA′, and “proposed” represents processing executed by the acoustic conversion system 100. “converntional” and “reference” represent methods to be compared.

“NS” in FIG. 11 indicates the musical instrument sound classification task NSynth. “USBK” in FIG. 11 indicates a classification task UrbanSound8k of environmental sounds such as a horn and a dog barking. “VC1” in FIG. 11 indicates the free utterance classification task VoxCelebi of 1251 speakers. “VE” in FIG. 11 indicates the classification task VoxForge of the free speech language. “SPCV2” in FIG. 11 indicates a classification task Speech commands V2 of voice commands. “SPCV2/12” in FIG. 11 indicates a classification task of voice commands of a voice command classification task Speech commands V2 obtained by compressing the SPCV2 into 12 labels.

Values with % in FIG. 11 indicate the accuracy of classification. That is, A % in FIG. 11 indicates that the accuracy of classification is A %. FIG. 11 illustrates that “BYOL-A” (that is, a method using acoustic conversion by the acoustic conversion system 100) is more accurate than other methods.

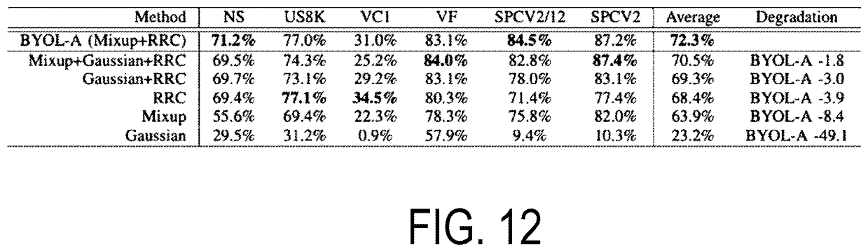

FIG. 12 is a second diagram illustrating a result of an experiment using the acoustic conversion system 100 of the embodiment. More specifically, FIG. 12 illustrates an example of a result of an experiment for separating the effect of the mix-up processing and the effect of the random resizing processing. “BYOL-A (Mixup+RRC)” in the column “Method” of FIG. 12 indicates that mix-up processing and random resizing processing are to be executed. “Mixup+Gaussian+RRC” in the column of “Method” in FIG. 12 indicates that after the mix-up processing is executed, the mix-up processing using the time series of Gaussian noise is further executed as the mixed time series, and then the random resizing processing is executed. “Gaussian+RRC” in the column of “Method” in FIG. 12 indicates that the mix-up processing and the random resizing processing using the time series of the Gaussian noise as the mixed time series are executed. “RRC” in the column of “Method” in FIG. 12 indicates that the random resizing processing is executed. “Mixuup” in the column of “Method” in FIG. 12 indicates that the mix-up processing is executed. “Gaussian” in the column of “Method” in FIG. 12 indicates that the mix-up processing using the time series of the Gaussian noise is executed as the mixed time series.

FIG. 12 illustrates that the performance of “SPCV2” is improved by performing the mix-up processing. Specifically, the accuracy of the three SPCV2 of “BYOL-A (Mixup+RRC)”, “Mixup+Gaussian+RRC”, and “Mixup” in which Mixup is executed is as high as 87.2, 87.4, and 82.0 in order.

The acoustic conversion system 100 configured as described above obtains data to be processed in the self-learning processing such as BYOL by executing the data augmentation processing. In the data augmentation processing, a duplication processing is performed. Therefore, in the acoustic conversion system 100, the data input to the self-learning processing such as BYOL does not need to be a pair of segments of a pair clipping from different times of one acoustic time series.

More specifically, in the acoustic conversion system 100, the pair of data input to the self-learning processing such as BYOL is a pair obtained using the same segment of one acoustic time series. Therefore, the acoustic conversion system 100 can appropriately convert the acoustic time series even when the assumption that the similarity between one and the other of the pairs is higher as the time interval is shorter and the similarity is lower as the time interval is longer is not true. Therefore, the acoustic conversion system 100 can improve the accuracy of conversion of the acoustic time series that is a time series of an acoustic sound.

### MODIFICATION EXAMPLE

Note that in the data augmentation processing, processing of normalizing the acoustic time series to be processed by the duplication processing (hereinafter referred to as “pre-normalization processing”) may be executed before the duplication processing is executed. Normalization in the pre-normalization processing is processing of converting the tensor representing the acoustic time series so that the distribution of each element of the tensor representing the acoustic time series is a predetermined distribution. The predetermined distribution is, for example, a distribution of a set of acoustic time series prepared in advance as a set of acoustic time series used in one batch processing.

In the data augmentation processing, after the random resizing processing is executed, processing (hereinafter, referred to as “posterior normalization processing”) of normalizing the time series indicated by the first extended data and the second extended data may be executed. The normalization in the posterior normalization processing is processing of converting each of the first output tensor and the second output tensor such that the distribution of each element of each tensor is a predetermined distribution for each of the first output tensor and the second output tensor.

The first output tensor is a tensor representing the time series indicated by the first extended data. The second output tensor is a tensor representing the time series indicated by the second extended data. The predetermined distribution is, for example, a distribution of a set of acoustic time series prepared in advance as a set of acoustic time series used in one batch processing.

Note that the first mixing time series preferably includes the foreground sound of the first partial time series. Note that the second mixing time series preferably includes the foreground sound of the second partial time series.

Note that the weight in the weighted average in the mix-up processing may be different at each time in the time axis direction, for example. The weight different at each time in the time axis direction may be, for example, a weight that monotonically increases with time or a weight that monotonically decreases. The weight different at each time in the time axis direction may be, for example, a weight according to a predetermined normal distribution having a peak at a predetermined time.

Note that the mix-up processing is not necessarily processing of obtaining a weighted average as long as it is processing of changing the partial time series using another time series for each of the first partial time series and the second partial time series. For example, for the first partial time series, the mix-up processing may be processing of obtaining a logarithm of a weighted average of a value having the value of the first partial time series on the shoulder of the exponential function and a value having the value of the first mixed time series on the shoulder of the exponential function. In addition, for example, for the second partial time series, the mix-up processing may be processing of obtaining a logarithm of a weighted average of a value having the value of the second partial time series on the shoulder of the exponential function and a value having the value of the second mixed time series on the shoulder of the exponential function.

As described above, the first weighted average processing is an example of the first mix-up processing, and the second weighted average processing is an example of the second mix-up processing. The first mix-up processing is processing of changing the first partial time series, which is one of the partial time series, using the first mixed time series, which is another time series. Therefore, the first mixing time series is the first partial time series after the change by the first mix-up processing.

The second mix-up processing is processing of changing the second partial time series that is the other of the partial time series using the second mixed time series that is different from the first mixed time series. Therefore, the second mixing time series is the second partial time series after the change by the second mix-up processing. Note that, as apparent from the above description, the first mix-up processing and the second mix-up processing are processing procedures included in the mix-up processing.

As described above, the conversion device 2 may be implemented as, for example, a search device that searches for a predetermined search target executing the learned acoustic conversion processing and using data in a target format obtained by executing the learned acoustic conversion processing. The processing of searching for a predetermined search target using the learned acoustic conversion processing is, for example, abnormality detection processing. In such a case, the inspection target is a predetermined abnormal sound. The processing of searching for a predetermined search target using the learned acoustic conversion processing may be, for example, music search processing. In such a case, the search target is a music. The processing of searching for a predetermined search target using the learned acoustic conversion processing may be, for example, speaker determination processing. In such a case, the search target is a speaker who has uttered a voice indicated by the acoustic time series input to the inspection device. The processing of searching for a predetermined search target using the learned acoustic conversion processing may be, for example, voice determination processing. In such a case, the search target is the voice itself indicated by the acoustic time series input to the inspection device.

Note that the conversion device 2 does not necessarily need to include the downstream processing execution unit 260, and the downstream processing execution unit 260 may be included in another device communicably connected to the conversion device 2. In such a case, the communication control unit 240 transmits the data in the target format to another device including the downstream processing execution unit 260 via the communication unit 23. Therefore, in such a case, the processing of step S203 among the processing of steps S201 to S204 executed by the conversion device 2 is not executed, and in the processing of step S204, the transmission of the data in the target format to another device by the communication control unit 240 is performed via the communication unit 23.

Each of the learning device 1 and the conversion device 2 may be implemented using a plurality of information processing devices communicably connected via a network. In this case, each functional unit included in each of the learning device 1 and the conversion device 2 may be implemented in a distributed manner in a plurality of information processing devices.

Note that the learning device 1 and the conversion device 2 do not necessarily need to be mounted as different devices. The learning device 1 and the conversion device 2 may be implemented as one device having both functions, for example.

All or some of the respective functions of the acoustic conversion system 100, the learning device 1, and the conversion device 2 may be realized by using hardware such as an application specific integrated circuit (ASIC), a programmable logic device (PLD), or a field programmable gate array (FPGA). The program may be recorded on a computer-readable recording medium. The “computer-readable recording medium” refers to, for example, a portable medium such as a flexible disk, a magneto-optical disc, a read-only memory (ROM), or a compact disc read-only memory (CD-ROM), or a storage device such as a hard disk built in a computer system. The program may be transmitted via an electrical communication line.

Although the embodiment of the present invention has been described in detail with reference to the drawings, specific configurations are not limited to the embodiment and include design and the like without departing from the gist of the present invention.

### REFERENCE SIGNS LIST

100 Acoustic conversion system
1 Learning device
2 Conversion device
11 Control unit
12 Input unit
13 Communication unit
14 Storage unit
15 Output unit
110 Acoustic time series acquisition unit
120 Data augmentation unit
130 Self-learning unit
140 Storage control unit
150 Communication control unit
160 Output control unit
21 Control unit
22 Input unit
23 Communication unit
24 Storage unit
25 Output unit
210 Acoustic time series acquisition unit
220 Conversion unit
230 Storage control unit
240 Communication control unit
250 Output control unit
91 Processor
92 Memory
93 Processor
94 Memory

1. A learning device comprising:
a processor; and
a storage medium having computer program instructions stored thereon, wherein the computer program instructions, when executed by the processor, perform processing of:
updating content of main conversion processing for converting data to be processed into data in a predetermined format by executing self-supervised learning; and
executing data augmentation processing of generating data to be processed in the main conversion processing based on an acoustic time series, wherein
acoustic time series clipping processing of clipping a partial time series that is a time series of a part of the acoustic time series, duplication processing of duplicating the partial time series, and conversion processing of converting one and the other of the partial time series according to a predetermined rule are performed in the data extension processing, and
the content of the main conversion processing is updated by self-supervised learning based on a result obtained by the conversion processing.

2. The learning device according to claim 1, wherein
the conversion processing includes first mix-up processing of changing a first partial time series that is one of partial time series using a first mixed time series that is another time series, and second mix-up processing of changing a second partial time series that is the other of partial time series using a second mixed time series different from the first mixed time series.

3. The learning device according to claim 2, wherein
using information indicating an intensity for each set of frequency and time as acoustic image data, the conversion processing includes first random resizing processing of executing affine conversion on at least a part of acoustic images expressing a first mixing time series that is a first partial time series after change by the first mix-up processing, and second random resizing processing of executing affine conversion on at least a part of acoustic images expressing a second mixing time series that is a second partial time series after change by the second mix-up processing.

4. The learning device according to claim 1, wherein
the conversion processing includes first random resizing processing of executing affine conversion on at least a part of an acoustic image representing a first partial time series that is one of partial time series, and second random resizing processing of executing affine conversion on at least a part of an acoustic image representing a second partial time series that is the other of partial time series.

5. A learning method comprising:
updating content of main conversion processing for converting data to be processed into data in a predetermined format by executing self-supervised learning; and
executing data augmentation processing of generating data to be processed in the main conversion processing based on an acoustic time series, wherein
in the data augmentation processing, acoustic time series clipping processing of clipping a partial time series that is a time series of a part of the acoustic time series, duplication processing of duplicating the partial time series, and conversion processing of converting one and the other of the partial time series according to a predetermined rule are performed, and
the content of the main conversion processing by self-supervised learning based on a result obtained by the conversion processing is updated.

6. A non-transitory computer readable medium which stores a program for causing a computer to function as the learning device according to claim 1.
